(19) United States
(12) Patent Application Publication
(10) Pub. No.: US 2006/0239685 A1
(43) Pub. Date: Oct. 26, 2006

(54) Method of transmitting a signal in a distributed bts system

(76) Inventor: Dong Moon Woo, Seoul (KR)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/560,506

(22) PCT Filed: Jul. 23, 2004
(86) PCT No.: PCT/KR04/01859

§ 371 Date: Jun. 15, 2006

(30) Foreign Application Priority Data
Jul. 24, 2003 (KR) 10 2003 0051168

(51) Int. Cl. H04B 10/00

(52) U.S. Cl. 398/115

(57) ABSTRACT

The present invention relates to a method of transmitting a signal in a distributed Base Transceiver Station (BTS) system that comprises a main unit and RF remote units. The present invention uses an optical coupler and RF couplers to transmit signals through multiple RF units, and thus extends the range of the signal transmission from 5˜10 Km to 20˜30 Km.

### TECHNICAL Field

The present invention relates to a method of transmitting a signal in a distributed Base Transceiver Station (BTS) system that comprises a main unit and BTS RF units. The present invention uses an optical coupler and RF couplers to transmit signals through multiple BTS RF units, and thus extends the range of the signal transmission from 5˜10 Km (convention) to 20˜30 Km.

### BACKGROUND ART

Generally, a distributed BTS system consists of a main unit, which handles channel generation and IF conversion, and a BTS RF unit (e.g., an RF remote unit), which handles RF conversion, transmission, and reception.

FIG. 1 shows the general connections within a distributed BTS system by optic cables. As shown in FIG. 1, a distributed BTS system consists of main unit (10), which handles modulation/demodulation of a channel signal and IF conversion of frequency, and BTS RF units (21, 22 and 23), which handle transmission/reception RF conversion and amplification of a channel signal.

The signal transmissions between the above two units are by microwave or optic cable. The present invention relates to a distributed BTS system utilizing an optic cable.

### DISCLOSURE OF INVENTION

Technical Problem

For a distributed BTS system utilizing an optic cable, the distance between the main unit and the BTS RF unit is restricted due to characteristics of the hardware.

The object of the present invention is to provide a method of transmitting signals in a distributed BTS system utilizing optic cables that allows the range of the signal transmission to be extended by using an optical coupler and RF couplers to transmit signals through multiple BTS RF units.

Technical Solution

To attain the object, the present invention suggests the following method of transmitting a signal in a distributed BTS system, comprising a BTS main unit and BTS RF units.

The method according to the present invention comprises the steps of:

generating a signal for mobile communication at the BTS main unit;

converting a signal into an intermediate frequency signal and outputting the converted signal from the BTS main unit;

receiving the outputted signal from the BTS main unit at the E/O (Electrical/Optical) converter, converting the received signal into a first optical signal, and transmitting the first optical signal to a first BTS RF unit;

converting the transmitted signal into an electrical signal using an O/E (Optical/Electrical) converter, and generating a coupled signal and a main signal from the electrical signal using an RF coupler;

transmitting the coupled signal to the first BTS RF unit, converting the main signal into a second optical signal, and transmitting the second optical signal to a second BTS RF unit;

separating the transmitted second optical signal into an optical coupled signal and an optical main signal using an optical coupler;

transmitting the optical coupled signal to the second BTS RF unit and transmitting the optical main signal to a third BTS RF unit; and

converting the optical coupled signal into an electrical signal to be used at the second BTS RF unit, and converting the optical main signal into an electrical signal to be used at the third BTS RF unit.

Advantageous Effects

The present invention uses an optical coupler and RF couplers to transmit signals through multiple BTS RF units, and thus extends the conventional range of the signal transmission from 5˜10 Km to 20˜30 Km.

### BRIEF DESCRIPTION OF THE DRAWINGS

FIG. 1 shows general connections of a distributed BTS system by optic cables.

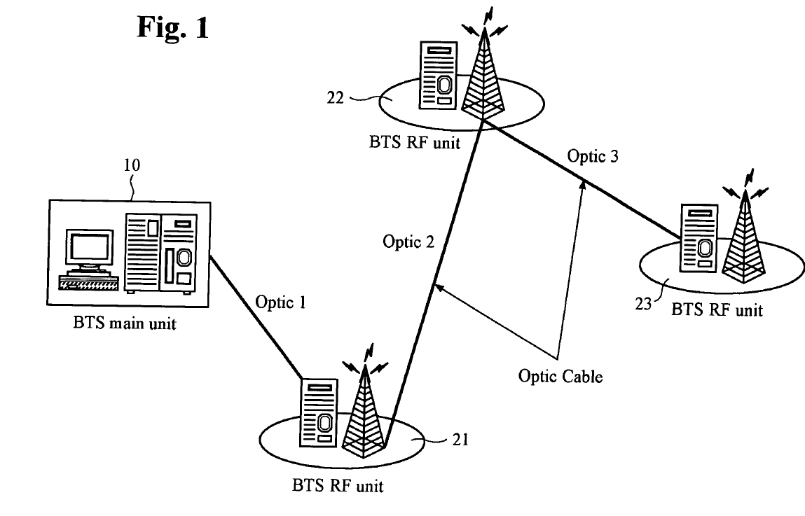

FIG. 2 shows an embodiment of a distributed BTS system using optical couplers and RF couplers according to the present invention.

FIG. 3 shows another embodiment of a distributed BTS system using optical coup lers and RF couplers according to the present invention.

### BEST MODE FOR CARRYING OUT THE INVENTION

The preferred embodiment of the present invention according to the above-mentioned technical features of the present invention is described below, together with the drawings.

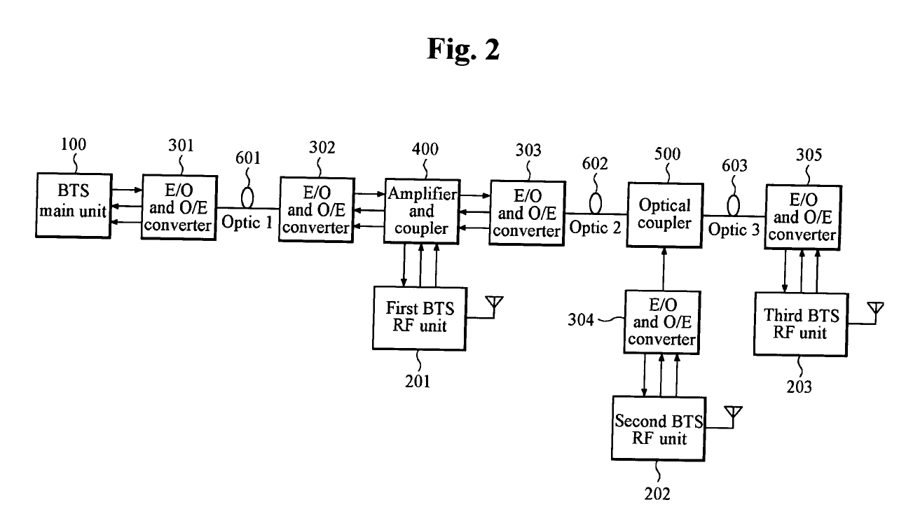

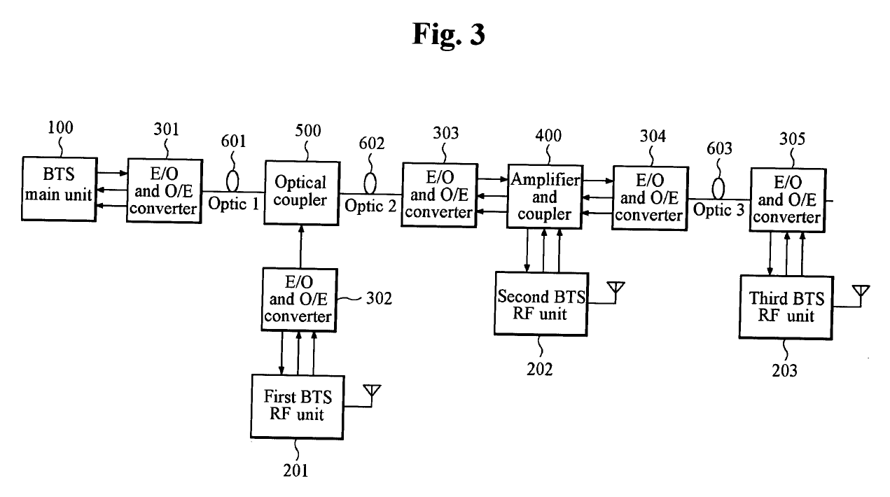

FIG. 2 shows an embodiment of a distributed BTS system using optical couplers and RF couplers according to the present invention. FIG. 3 shows another embodiment of a distributed BTS system using optical couplers and RF couplers according to the present invention.

As shown in FIG. 2, a distributed BTS system comprises main unit (100), one or more BTS RF units (201, 202 and 203) (e.g., RF remote units), and several modules that connect main unit (100) and BTS RF units (201, 202 and 203).

The modules include E/O (Electrical/Optical) and O/E (Optical/Electrical) converters (301˜305), RF amplifier and coupler (400), optic coupler (500), and optic cables (601, 602 and 603).

The operations of the distributed BTS system, constituted as shown in FIG. 2, according to the present invention, are as follows:

First, a signal channel for mobile communication is generated at BTS main unit (100), converted into an intermediate frequency signal, and outputted from BTS main unit (100).

Next, the outputted signal from BTS main unit (100) is converted into a first optical signal at E/O converter (301), and transmitted to first BTS RF unit (201).

Next, the transmitted signal is converted into an electrical signal using O/E converter (302), and divided into a coupled signal and a main signal at RF coupler (400).

Wherein, the coupled signal is transmitted to first BTS RF unit (201), and the main signal is converted into a second optical signal and transmitted to second BTS RF unit (202).

The transmitted second optical signal is divided into an optical coupled signal and an optical main signal using optical coupler (500). Wherein, the optical coupled signal is transmitted to second BTS RF unit (202), and the optical main signal is transmitted to third BTS RF unit (203).

The optical coupled signal is converted into an electrical signal to be used at second BTS RF unit (202), and the optical main signal is also converted into an electrical signal to be used at third BTS RF unit (203).

The maximum allowable distance for each section is 5˜10 Km. FIG. 3 shows another embodiment of a distributed BTS system according to the present invention, that uses the similar principle of the system of FIG. 2.

### INDUSTRIAL APPLICABILITY

The present invention uses an optical coupler and RF couplers to transmit signals through multiple BTS RF units, and thus extends the range of the signal transmission from 5˜10 Km to 20˜30 Km.

Although the present invention was described with respect to particular embodiments of the apparatus of selecting, it will be apparent to those skilled in the art that many changes and modifications may be made without departing from the scope of the invention as defined in the appended claim and those equivalent thereto.

1. A method of transmitting a signal in a distributed BTS (Base Transceiver Station) system comprising a BTS main unit and BTS RF units, said method comprising the steps of:
generating a signal for mobile communication at the BTS main unit;
converting the signal into a intermediate frequency signal and outputting the converted signal from the BTS main unit;
receiving the outputted signal from the BTS main unit at an E/O (Electrical/Optical) converter, converting the received signal into a first optical signal, and transmitting the first optical signal to a first BTS RF unit;
converting the transmitted signal into an electrical signal using an O/E (Optical/Electrical) converter, and generating a coupled signal and a main signal from the electrical signal using an RF coupler;
transmitting the coupled signal to the first BTS RF unit, converting the main signal into a second optical signal, and transmitting the second optical signal to a second BTS RF unit;
separating the transmitted second optical signal into an optical coupled signal and an optical main signal using an optical coupler;
transmitting the optical coupled signal to the second BTS RF unit and transmitting the optical main signal to a third BTS RF unit; and
converting the optical coupled signal into an electrical signal to be used at the second BTS RF unit, and converting the optical main signal into an electrical signal to be used at the third BTS RF unit.
